(19) United States
(12) Patent Application Publication
(10) Pub. No.: US 2006/0007115 A1
(43) Pub. Date: Jan. 12, 2006

(54) Display device for presentation

(75) Inventors: Toshinori Furuhashi, Tochigi (JP); Kazuya Arakawa, Tochigi (JP); Shigeru Kojima, Tochigi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, OSAKA-SHI OSAKA (JP)

(21) Appl. No.: 10/522,747

(22) PCT Filed: Jul. 17, 2003
(86) PCT No.: PCT/JP03/09094

§ 371 Date: Jan. 28, 2005

(30) Foreign Application Priority Data
Jul. 31, 2002 (JP) 2002-223454

(51) Int. Cl. G09G 5/00

(52) U.S. Cl. 345/156

(57) ABSTRACT

In a display apparatus for presentation including an image display device 30 that allows for moving a selection marker across a plurality of menu items arranged in vertical and horizontal directions and displayed on a screen 1 in accordance with received angular velocity information, a menu item to which the selection marker should be moved is determined in accordance with the number of cycles of angular velocity sampling during which the move distance of the pointing device obtained for every sampling cycle from the angular velocity information exceeds a predetermined value continuously. This improved the inconvenience to use with a conventional pointing device in which a distance by which an object should be moved on the display screen is proportional to the entire distance over which the pointing device was moved, calculated from angular velocity; thus, the operator has to tilt the remote controller incorporating a gyroscope to a large extent to move the object by a long distance on the screen.

### TECHNICAL FIELD

The present invention relates to a display apparatus for presentation configured with a pointing device consisting of a remote controller incorporating a gyroscope (hereinafter referred to as a Gyro remote controller) and a projection type image display device such as a liquid crystal projector.

### BACKGROUND ART

Recently, pointing devices have increasingly been used for effective presentation in conjunction with displaying compute-based images and animation images with a projection type image display device such as a liquid crystal projector, and a pointing device using a Gyro remote controller has been proposed. The device using the Gyro remote controller samples relative position information for two points between which the pointing device was moved per given period of time, as the device is moved in a direction, and transmits the relative position information to a display device. Based on the relative position information received, the display device can perform moving the selection from one menu item to another in a main menu on its screen, moving a cursor or pointer, panning an image, or picture-in-picture moving.

### DISCLOSURE OF THE INVENTION

However, a conventional pointing device consisting of the Gyro remote controller works in such a manner that, for instance, when selecting a menu item, the selection is moved to the menu item only after the entire distance over which the pointing device was moved, obtained from received data, exceeds a predefined value. Therefore, the operator has to move the Gyro remote controller to a large extent in order to move an object by a long distance on the screen and may feel inconvenience to use. As countermeasures, it is conceivable to increase sensitivity. However, increasing sensitivity gives rise to a problem of difficulty in control of a minor move, because the sensed move distance becomes excessively great even by moving the pointing device by a small distance. When increasing or decreasing a value or moving the pointer on the display with the pointing device, such value change or move is performed at a constant rate in the conventional manner. If the amount of change or the distance of move is great, the operator has to operate the pointing device for a long time, which posed a problem of poor user-friendliness.

To solve the above problems, the present invention provides a display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of moving a selection marker across a plurality of menu items arranged in vertical and horizontal directions and displayed on a screen in accordance with the received angular velocity information, characterized by provision of means for determining a menu item to which the selection marker should be moved in accordance with the number of cycles of sampling the angular velocities during which the move distance of the pointing device obtained for every sampling cycle from the angular velocity information exceeds a predetermined value continuously.

Also, the present invention provides a display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of presenting an indicator for value setting in a menu item displayed on a screen and making the indicator slide in a value incremental or decremental direction in accordance with the received angular velocity information, characterized by provision of means for determining the amount of increment or decrement of the indicator for value setting in accordance with the number of cycles of sampling the angular velocities during which the move distance of the pointing device obtained for every sampling cycle from the angular velocity information exceeds a predetermined value continuously.

Also, the present invention provides a display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a panning function of moving an image displayed on a screen in accordance with the received angular velocity information, characterized by provision of means for panning by a distance in accordance with the number of cycles of sampling the angular velocities during which the move distance of the pointing device obtained for every sampling cycle from the angular velocity information exceeds a predetermined value continuously.

Also, the present invention provides a display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a picture-in-picture function to move or enlarge a sub-screen displayed on a screen in accordance with the received angular velocity information, characterized by moving or enlarging the sub-screen by a distance in accordance with the number of cycles of sampling the angular velocities during which the move distance of the pointing device obtained for every sampling cycle from the angular velocity information exceeds a predetermined value continuously.

Also, the present invention provides a display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of presenting an indicator for value setting in a menu item displayed on a screen and making the indicator slide in a value incremental or decremental direction in accordance with the received angular velocity information, characterized by provision of means for changing the rate of increment or decrement of the indicator for value setting in accordance with the number of cycles of sampling the angular velocities during which the move distance of the pointing device obtained for every sampling cycle from the angular velocity information exceeds a predetermined value continuously.

Also, the present invention provides a display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of moving a cursor or pointer displayed on a screen in accordance with the received angular velocity information, characterized by provision of means for moving the cursor or pointer by a distance in accordance with the number of cycles of sampling the angular velocities during which the move distance of the pointing device obtained for every sampling cycle from the angular velocity information exceeds a predetermined value continuously.

Also, the present invention provides a display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of moving a pointer displayed on a screen in accordance with the received angular velocity information, characterized by provision of means for changing the rate at which the pointer moves in accordance with the number of cycles of sampling the angular velocities during which the move distance of the pointing device obtained for every sampling cycle from the angular velocity information exceeds a predetermined value continuously.

### BRIEF DESCRIPTION OF THE DRAWINGS

FIG. 1 is a block diagram showing a configuration of a display apparatus of the present invention.

FIG. 2 shows an on-screen display example according to the present invention in a first embodiment.

FIG. 3 shows an on-screen display example according to the present invention in a second embodiment.

FIG. 4 shows an on-screen display example according to the present invention in a third embodiment.

FIG. 5 shows an on-screen display example according to the present invention in a fourth embodiment.

FIG. 6 shows an on-screen display example according to the present invention in a fifth embodiment.

FIG. 7 is a graph showing a relationship between the number of cycles of sampling and the rate at which the value increases in FIG. 3.

FIG. 8 shows an on-screen display example according to the present invention in a sixth embodiment.

FIG. 9 is a graph showing a relationship between the number of cycles of sampling and the rate at which the pointer moves in FIG. 8.

### BEST MODE FOR CARRYING OUT THE INVENTION

Embodiments of the present invention will be described hereinafter in conjunction with the drawings.

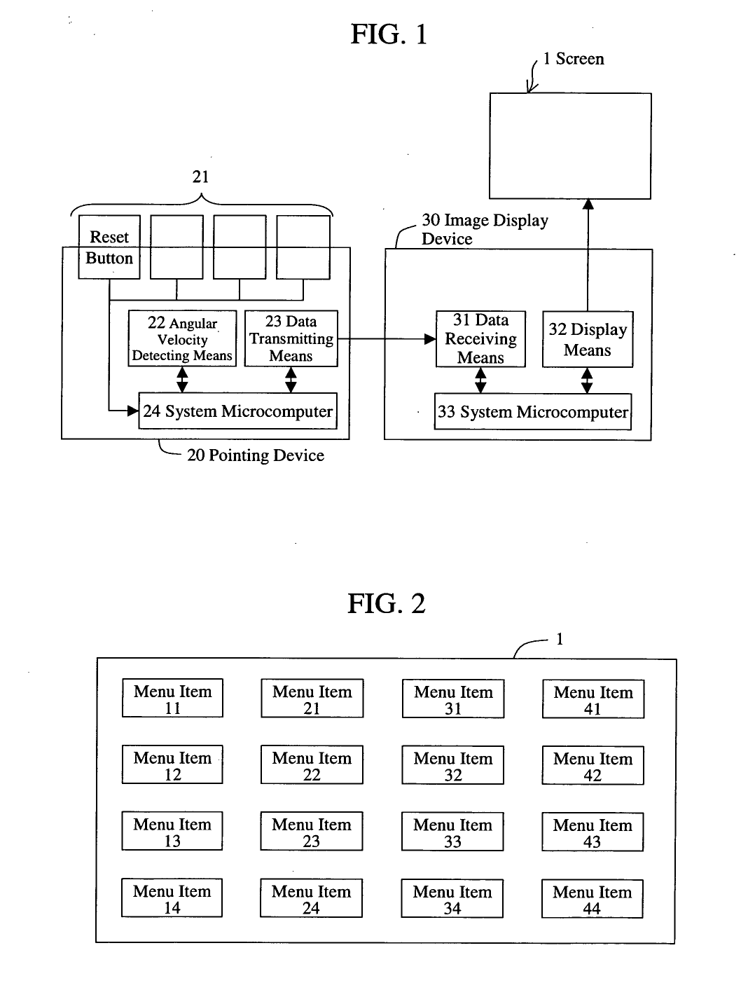

FIG. 1 is a block diagram showing a configuration of a display apparatus for presentation according to the present invention. In the diagram, reference numeral 1 denotes a screen. Reference numeral 20 denotes a pointing device that is made up of buttons 21 such as a reset button, an angular velocity detecting means 22, a data transmitting means 23, and a system microcomputer 24 of the pointing device. Reference numeral 30 denotes an image display device that is made up of a data receiving means 31, a display means 32, and a system microcomputer 33 of the image display device. Here, the angular velocity detecting means 22 consists of a gyroscope and converts three-dimensional information into two dimensional-information in horizontal and vertical directions, and reads (samples) relative position information for two points between which the pointing device was moved per given period of time and detects the relative positions of the two points. The detected relative position information is wirelessly transmitted from the data transmitting means 23 to the data receiving means 31. The display apparatus for presentation is constituted by the above elements. A computer-based image not shown is projected on the screen 1 from the image display device 30 and the image can be displayed and manipulated in various ways with the pointing device 20.

FIG. 2 shows a display example on the screen 1 according to the present invention in a first embodiment. On the screen 1, an array of menu items arranged in both vertical and horizontal directions may be displayed in an initial screen or the like. On this screen, a selected menu item may be changed in color or brightness or highlighted. Using the pointing device 20, the operator can move the selection marker from an initially selected top left menu item in the vertical or horizontal direction and eventually select an objective menu item. Specifically, when the operator moves the pointing device 20, the angular velocity detecting means 22 samples relative position information for two points between which the pointing device was moved per given period of time from the horizontal and vertical angular velocities and detects the relative positions of the two points, and the data transmitting means 23 transmits the relative position information to the data receiving means 31 of the image display device 30. Then, the system microcomputer 33 of the image display device 30 that received the relative position information calculates the distance of the move by integration of that information. Then, a menu item to which the selection marker should be moved is determined in accordance with the number of cycles of sampling during which the move distance of the pointing device obtained for every sampling cycle exceeds a predetermined value continuously.

For example, in a state where a menu item 11 is initially selected on the screen 1 shown in FIG. 2, when the pointing device 20 is moved horizontally, sampling of angular velocity values of the moving pointing device is performed at intervals of 10 msec. If the horizontal move distance of the pointing device exceeds a fixed value for five successive cycles of sampling, the marker is moved to a menu item 21. If this continues for further five successive cycles of sampling (a total of 10 cycles), the marker is moved to a menu item 31. If this continues for further five successive cycles of sampling (a total of 15 cycles), the marker is moved to a menu item 41.

Likewise, when the pointing device 20 is moved vertically, according to the number of successive cycles (duration) of sampling during which the move distance of the pointing device calculated for every sampling cycle exceeds a predetermined value, the selection marker will be moved to a menu item 12, menu item 13, etc. In this example, a menu item to which the marker should be moved is determined in proportion to the number of cycles of sampling (time) during which the pointing device continues to be moved, not subject to the entire distance over which the pointing device 20 was moved. Thus, the operator is allowed to move the pointing device slowly, taking longer, in order to move across multiple menu items. In consequence, the operator does not need to move the pointing device 20 to a large extent.

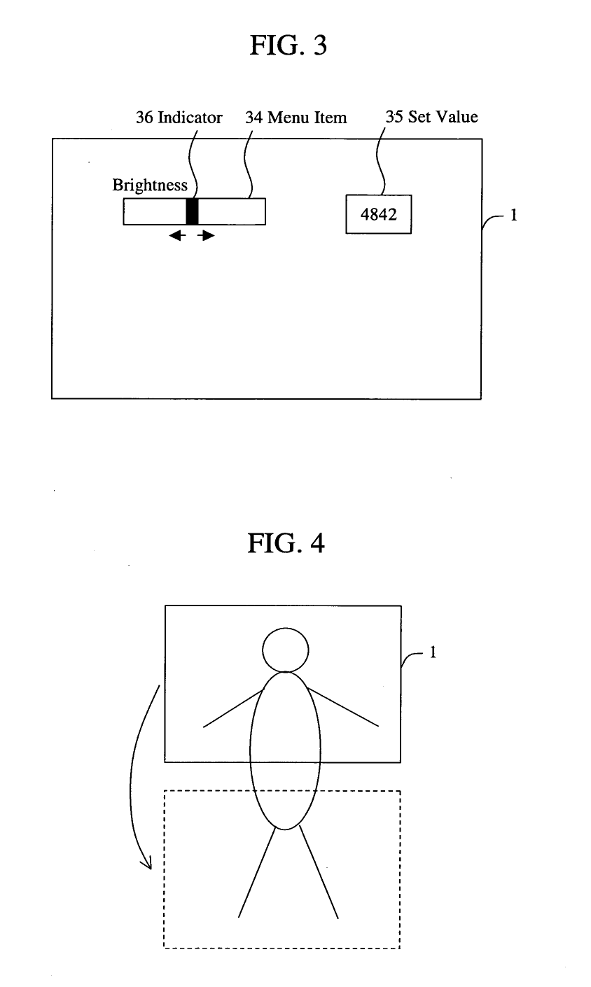

FIG. 3 shows a display example on the screen 1 according to the present invention in a second embodiment. A menu item selected on the screen 1 shown in FIG. 2 may be, for instance, the one for brightness value setting. This value setting menu item is illustrated in FIG. 3. In the menu item 34, an indicator 36 is shown for visual indication that slides to the right or left in accordance with an increase or decrease in a set value 35. This indicator 36 slides in an incremental or decremental direction in parallel with a horizontal movement of the pointing device 20 made by the operator. Specifically, when the operator moves the pointing device 20 horizontally, the angular velocity detecting means 22 samples relative position information for two points between which the pointing device was moved per given period of time from the horizontal angular velocity and detects the relative positions of the two points, and the data transmitting means 23 transmits the relative position information to the data receiving means 31 of the image display device 30. Then, the system microcomputer 33 of the image display device 30 that received the relative position information calculates the distance of the move by integration of that information. Then, the amount of increment or decrement of the indicator 36 is determined in accordance with the number of cycles of sampling during which the move distance of the pointing device obtained for every sampling cycle exceeds a predetermined value continuously.

For example, in a state where a value of 4820 is initially set on the screen 1 shown in FIG. 3, when the pointing device 20 is moved horizontally in an increment direction, the system microcomputer 33 of the image display device is furnished with the relative position information sampled at intervals of 10 msec. If the horizontal move distance of the pointing device exceeds a fixed value for five successive cycles of sampling, the amount of increment is determined to be 50 and the indicator slides to a position corresponding to 4870. If this continues for further five successive cycles of sampling (a total of 10 cycles), the amount of increment is determined to be 100 and the indicator slides to a position corresponding to 4920. If this continues for further five successive cycles of sampling (a total of 15 cycles), the amount of increment is determined to be 150 and the indicator slides to a position corresponding to 4970. If this continues for further five successive cycles of sampling (a total of 20 cycles), the amount of increment is determined to be 200 and the indicator slides to a position corresponding to 5020. In this example as well, a position to which the indicator should slide is determined in proportion to time during which the pointing device continues to be moved, not subject to the entire distance over which the pointing device 20 was moved. Thus, the operator is allowed to move the pointing device slowly, taking longer, in order to change the set value in a large amount of increment or decrement. In consequence, the operator does not need to move the pointing device 20 to a large extent.

FIG. 4 shows a display example on the screen 1 according to the present invention in a third embodiment. The operator may want to pan an image displayed on the screen 1. For example, if panning from the upper part of a full-length figure of a person displayed to its lower part image is performed, after the screen is set enabled for panning, as the operator moves the pointing device 20 vertically, the screen 1 is relatively scrolled downward. This results in the effect of moving the image upward. Specifically, when the operator moves the pointing device 20 vertically, the angular velocity detecting means 22 samples relative position information for two points between which the pointing device was moved per given period of time from the angular velocity and detects the relative positions of the two points, and the data transmitting means 23 transmits the relative position information to the data receiving means 31 of the image display device 30. Then, the system microcomputer 33 of the image display device 30 that received the relative position information calculates the distance of the move by integration of that information. Then, the image is panned by a distance in accordance with the number of cycles of sampling during which the move distance of the pointing device obtained for every sampling cycle exceeds a predetermined value continuously.

For example, in a state where the upper part of the full image of a person is displayed on the screen 1 shown in FIG. 4, when the pointing device 20 is moved vertically, the system microcomputer 33 of the image display device is furnished with the relative position information sampled at intervals of 10 msec. If the vertical move distance of the pointing device exceeds a fixed value for five successive cycles of sampling, the image is moved by a distance corresponding to 20% of the screen height. If this continues for further five successive cycles of sampling (a total of 10 cycles), the image is moved by a distance corresponding to 40% of the screen height. If this continues for further five successive cycles of sampling (a total of 15 cycles), the image is moved by a distance corresponding to 60% of the screen height. If this continues for further five successive cycles of sampling (a total of 20 cycles), the image is moved by a distance corresponding to 80% of the screen height. The image is thus moved and its lower part is gradually displayed on the screen. In this example as well, a distance by which the image should be moved is determined in proportion to time during which the pointing device continues to be moved, not subject to the entire distance over which the pointing device 20 was moved. Thus, the operator is allowed to move the pointing device slowly, taking longer, in order to pan an image by a great distance. In consequence, the operator does not need to move the pointing device 20 to a large extent.

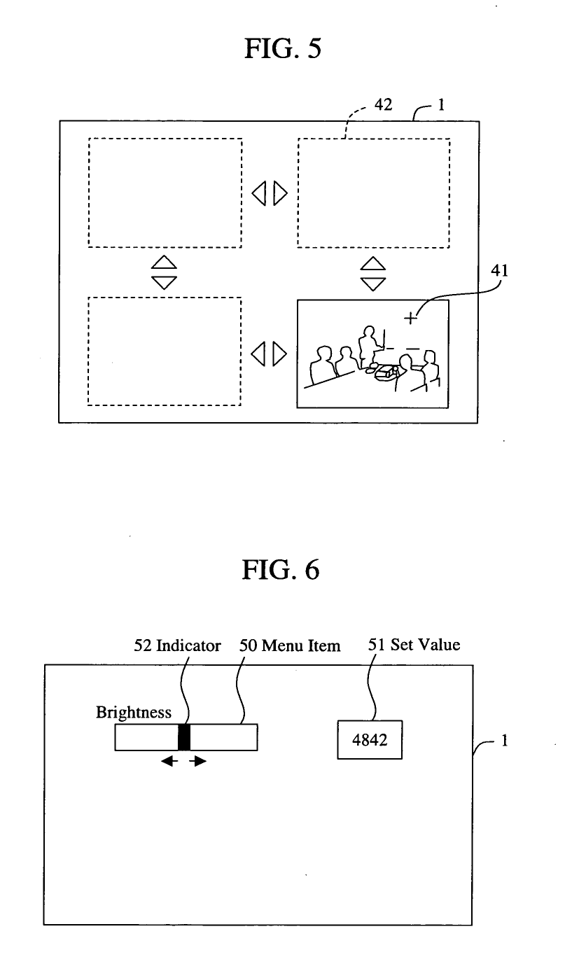

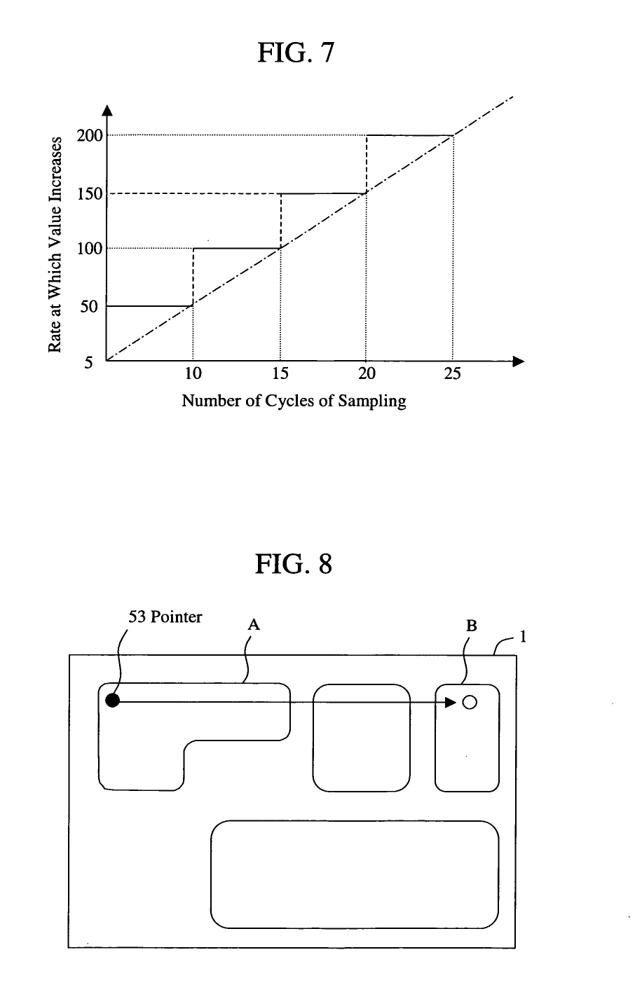

FIG. 5 shows a display example on the screen 1 according to the present invention in a fourth embodiment. On the screen 1, sub-screens 42 may be displayed in a displayed image through the use of a picture-in-picture function. The display device can be equipped with functions of gradually enlarging a sub-screen 42 in the screen 1, enlarging it to a full-screen display, and moving it across the screen 1, and the operator can perform these functions by moving a cursor 41 into an objective sub-screen 42 and operating a specific button and the pointing device 20.

As a concrete method of moving the cursor 41 into a sub-screen 42, when the operator moves the pointing device 20 to move the cursor 41, the angular velocity detecting means 22 samples relative position information for two points between which the pointing device was moved per given period of time from the horizontal and vertical angular velocities and detects the relative positions of the two points, and the data transmitting means 23 transmits the relative position information to the data receiving means 31 of the image display device 30. Then, the system microcomputer 33 of the image display device 30 that received the relative position information calculates the distance of the move by integration of that information. Then, a position to which the cursor 41 should be moved is determined in accordance with the number of cycles of sampling during which the move distance of the pointing device obtained for every sampling cycle exceeds a predetermined value continuously.

An example of operation of moving the cursor 41 into a sub-screen 42 is described, assuming that the display device has the function of enlarging the sub-screen 42 to a full-screen display at once on the screen 1.

In a state where the cursor 41 is positioned at top left on the screen 1 shown in FIG. 5, when the pointing device 20 is moved horizontally, the system microcomputer 33 of the image display device is furnished with the relative position information sampled at intervals of 10 msec. If the horizontal move distance of the pointing device exceeds a fixed value for five successive cycles of sampling, the cursor is moved by a distance corresponding to 20% of the screen width. If this continues for further five successive cycles of sampling (a total of 10 cycles), the cursor is moved by a distance corresponding to 40% of the screen width. If this continues for further five successive cycles of sampling (a total of 15 cycles), the cursor is moved by a distance corresponding to 60% of the screen width. If this continues for further five successive cycles of sampling (a total of 20 cycles), the cursor is moved by a distance corresponding to 80% of the screen width. After the cursor is thus moved up to a position within a top right sub-screen 42, by pressing an instantly zoom-in button 21a, the sub-screen 42 is enlarged to a full-screen display on the screen 1. In this example as well, a distance by which the cursor 41 should be moved is determined in proportion to time during which the pointing device continues to be moved, not subject to the entire distance over which the pointing device 20 was moved. Thus, the operator is allowed to move the pointing device slowly, taking longer, in order to move the cursor by a large distance. In consequence, the operator does not need to move the pointing device 20 to a large extent.

Next, an example of operation of moving a sub-screen 42 across the screen is described.

In the state where the cursor 41 is positioned at top left on the screen 1 shown in FIG. 5, the cursor 41 is moved into the objective sub-screen 42 in the same way of operation as described above. After the cursor 41 has been moved into the sub-screen 42, when the pointing device 20 is moved horizontally, while a move button 2 is pressed, the system microcomputer 33 of the image display device is furnished with the relative position information sampled at intervals of 10 msec. If the horizontal move distance of the pointing device exceeds a fixed value for five successive cycles of sampling, the sub-screen 42 is moved by a distance corresponding to 20% of the screen width. If this continues for further five successive cycles of sampling (a total of 10 cycles), the sub-screen 42 is moved by a distance corresponding to 40% of the screen width. If this continues for further five successive cycles of sampling (a total of 15 cycles), the sub-screen 42 is moved by a distance corresponding to 60% of the screen width. If this continues for further five successive cycles of sampling (a total of 20 cycles), the sub-screen 42 is moved by a distance corresponding to 80% of the screen width. In this example as well, a distance by which the sub-screen 42 should be moved is determined in proportion to time during which the pointing device continues to be moved, not subject to the entire distance over which the pointing device 20 was moved. Thus, the operator is allowed to move the pointing device slowly, taking longer, in order to move the sub-screen by a large distance. In consequence, the operator does not need to move the pointing device 20 to a large extent.

FIG. 6 shows a display example on the screen 1 according to the present invention in a fifth embodiment. In a menu item 50, an indicator 52 is shown for visual indication that slides to the right or left in accordance with an increase or decrease in a set value 51. This indicator 52 slides in an incremental or decremental direction in parallel with a horizontal movement of the pointing device 20 made by the operator. Specifically, when the operator moves the pointing device 20 horizontally, the angular velocity detecting means 22 samples relative position information for two points between which the pointing device was moved per given period of time from the horizontal angular velocity and detects the relative positions of the two points, and the data transmitting means 23 transmits the relative position information to the data receiving means 31 of the image display device 30. Then, the system microcomputer 33 of the image display device 30 that received the relative position information calculates the distance of the move by integration of that information. Then, the rate of increment or decrement of the indicator 27 is changed in accordance with the number of cycles of sampling during which the move distance of the pointing device obtained for every sampling cycle exceeds a predetermined value continuously.

For example, in a state where a brightness value of 4820 is initially set on the screen 1 shown in FIG. 6, when the pointing device 20 is moved horizontally in an increment direction, the system microcomputer 33 of the image display device is furnished with the relative position information sampled at intervals of 10 msec. If the horizontal move distance of the pointing device exceeds a fixed value for five successive cycles of sampling, the rate at which the value increases is changed to 50/sec. If this continues for further five successive cycles of sampling (a total of 10 cycles), the rate at which the value increases is changed to 100/sec. If this continues for further five successive cycles of sampling (a total of 15 cycles), the rate at which the value increases is changed to 150/sec. If this continues for further five successive cycles of sampling (a total of 20 cycles), the rate at which the value increases is changed to 200/sec. This relationship between time and the rate at which the value increases is shown in a graph of FIG. 3. In this way, the rate at which the value increases and the indicator slides accordingly is determined in proportion to time during which the pointing device continues to be moved, not subject to the entire distance over which the pointing device 20 was moved. Thus, the rate at which the value increases is changed so that it will be accelerated over time. That is, the operator is allowed to move the pointing device slowly, taking longer, in order to change the set value greatly. In consequence, the operator does not need to move the pointing device 20 to a large extent.

FIG. 8 shows a display example on the screen 1 according to the present invention in sixth and seventh embodiments. On the screen, a pointer 53 may be shown to point to a particular portion of an image displayed. The pointer 53 is moved by moving the pointing device 20. In particular, a movement of this pointer 53 pointing to an image A to an image B is carried out by moving the pointing device 20 horizontally. Specifically, when the pointing device 20 is moved, the angular velocity detecting means 22 samples relative position information for two points between which the pointing device was moved per given period of time from the horizontal angular velocity and detects the relative positions of the two points, and the data transmitting means 23 transmits the relative position information to the data receiving means 31 of the image display device 30. Then, the system microcomputer 33 of the image display device 30 that received the relative position information calculates the distance of the move by integration of that information. Then, the speed at which the pointer 53 moves is accelerated in accordance with the number of cycles of sampling during which the move distance of the pointing device obtained for every sampling cycle exceeds a predetermined value continuously.

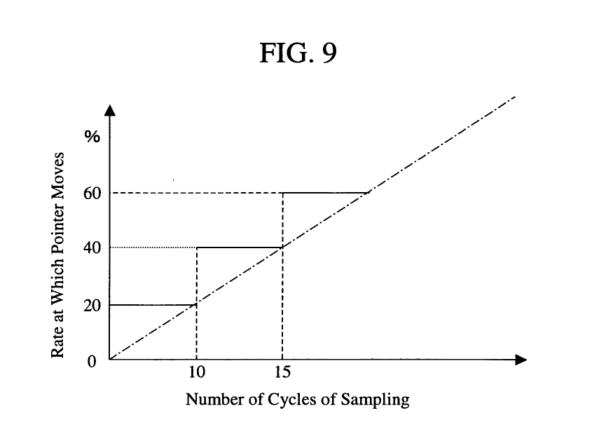

For example, in a state where the pointer 53 is positioned in the image A at top left on the screen 1 shown in FIG. 8, when the pointing device 20 is moved to the right horizontally, the system microcomputer 33 of the image display device is furnished with angular velocity values sampled at intervals of 10 msec. If the horizontal move distance of the pointing device exceeds a fixed value for five successive cycles of sampling, the pointer moves at a rate of 20% of the screen width per second. If this continues for further five successive cycles of sampling (a total of 10 cycles), the pointer moves at a rate of 40% of the screen width per second. If this continues for further five successive cycles of sampling (a total of 15 cycles), the pointer moves at a rate of 60% of the screen width per second. This relationship between time and the rate is shown in a graph of FIG. 9. In this example as well, the rate at which the pointer moves is determined in proportion to time during which the pointing device continues to be moved, not subject to the entire distance over which the pointing device 20 was moved. Thus, the pointer moves at an accelerating rate over time. That is, the operator is allowed to move the pointing device slowly, taking longer, in order to move the pointer greatly. In consequence, the operator does not need to move the pointing device 20 to a large extent.

A practical display apparatus for presentation can be configured in combinations of the above first to seventh embodiments of the present invention. In this relation, it is preferable to vary the sensitivity of move distance calculation for every sampling cycle from relative position information, according to application. For improved usability, for instance, it is advisable to apply the normal sensitivity for selecting a menu item, adjusting the value in a menu item, and picture-in-picture operation, a two-fold sensitivity for moving the pointer, and a three-fold sensitivity for panning.

### INDUSTRIAL APPLICABILITY

According to the present invention as described hereinbefore, by provision of means for determining a menu item to which the selection marker should be moved in accordance with the number of cycles of sampling during which the move distance of the pointing device obtained for every sampling cycle from angular velocity information exceeds a predetermined value continuously, moving to a desired menu item can be performed by continuing to move the pointing device for a given time or longer and usability is enhanced.

Also, by provision of means for determining the amount of increment or decrement of an indicator for value setting in accordance with the number of cycles of sampling during which the move distance of the pointing device obtained for every sampling cycle from angular velocity information exceeds a predetermined value continuously, it becomes easy to change the setting to a desired value by continuing to tilt the pointing device for a given time or longer and usability is enhanced.

Also, by provision of means for panning by a distance in accordance with the number of cycles of sampling during which the move distance of the pointing device obtained for every sampling cycle from angular velocity information exceeds a predetermined value continuously, panning to a desired image portion can be performed by continuing to tilt the pointing device for a given time or longer and usability is enhanced.

Also, by provision of means for moving to a sub-screen by a distance in accordance with the number of cycles of sampling during which the move distance of the pointing device obtained for every sampling cycle from angular velocity information exceeds a predetermined value continuously, picture-in-picture moving to a desired sub-screen can be performed by continuing to tilt the pointing device for a given time or longer and usability is enhanced.

Also, the rate of increment or decrement of an indicator for value setting can be changed in accordance with the number of cycles of sampling during which the move distance of the pointing device obtained for every sampling cycle from angular velocity information exceeds a predetermined value continuously; thereby, it becomes easy to change the setting to a desired value by continuing to tilt the pointing device for a given time or longer and usability is enhanced.

Furthermore, the rate at which the pointer moves can be changed in accordance with the number of cycles of sampling during which the move distance of the pointing device obtained for every sampling cycle from angular velocity information exceeds a predetermined value continuously; thereby, moving to a desired position can be performed by continuing to tilt the pointing device for a given time or longer and usability is enhanced.

1. A display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of moving a selection marker across a plurality of menu items arranged in vertical and horizontal directions and displayed on a screen in accordance with the received angular velocity information,
the display apparatus for presentation characterized by provision of means for determining a menu item to which the selection marker should be moved in accordance with the duration of sampling the angular velocities during which the move distance of the pointing device obtained for every sampling cycle from said angular velocity information exceeds a predetermined value continuously.

2. A display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of presenting an indicator for value setting in a menu item displayed on a screen and making the indicator slide in a value incremental or decremental direction in accordance with the received angular velocity information,
the display apparatus for presentation characterized by provision of means for determining the amount of increment or decrement of the indicator for value setting in accordance with the duration of sampling the angular velocities during which the move distance of the pointing device obtained for every sampling cycle from said angular velocity information exceeds a predetermined value continuously.

3. A display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a panning function of moving an image displayed on a screen in accordance with the received angular velocity information,
the display apparatus for presentation characterized by provision of means for panning by a distance in accordance with the duration of sampling the angular velocities during which the move distance of the pointing device obtained for every sampling cycle from said angular velocity information exceeds a predetermined value continuously.

4. A display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a picture-in-picture function to move or enlarge a sub-screen displayed on a screen in accordance with the received angular velocity information, the display apparatus for presentation characterized by moving or enlarging the sub-screen by a distance in accordance with the duration of sampling the angular velocities during which the move distance of the pointing device obtained for every sampling cycle from said angular velocity information exceeds a predetermined value continuously.

5. A display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of presenting an indicator for value setting in a menu item displayed on a screen and making the indicator slide in a value incremental or decremental direction in accordance with the received angular velocity information,
the display apparatus for presentation characterized by provision of means for changing the rate of increment or decrement of the indicator for value setting in accordance with the duration of sampling the angular velocities during which the move distance of the pointing device obtained for every sampling cycle from said angular velocity information exceeds a predetermined value continuously.

6. A display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of moving a cursor or pointer displayed on a screen in accordance with the received angular velocity information,
the display apparatus for presentation characterized by provision of means for moving the cursor or pointer by a distance in accordance with the duration of sampling the angular velocities during which the move distance of the pointing device obtained for every sampling cycle from said angular velocity information exceeds a predetermined value continuously.

7. A display apparatus for presentation comprising a pointing device equipped with means for detecting angular velocities in horizontal and vertical directions and means for transmitting detected angular velocity information and an image display device having means for receiving angular velocity information transmitted from the pointing device and equipped with a function of moving a pointer displayed on a screen in accordance with the received angular velocity information,
the display apparatus for presentation characterized by provision of means for changing the rate at which the pointer moves in accordance with the duration of sampling the angular velocities during which the move distance of the pointing device obtained for every sampling cycle from said angular velocity information exceeds a predetermined value continuously.

8. A display system comprising a display device and a pointing device associated with the display device and for use to operate upon an object to change displayed on a display screen by said display device, the display system characterized by including:
a position information detecting means for detecting position information on positions indicated by said pointing device;
a move information sampling means for sampling the move distance between said indicated positions per unit time, based on the position information detected by the position information detecting means; and
a change amount determining means for determining the amount of change of said object to change on said display screen, based on the duration of sampling during which the move distance between said indicated positions per unit time, sampled by the move information sampling means, exceeds a threshold continuously.

9. A pointing device associated with a display device and for use to operate upon an object to change displayed on a display screen by the display device, the pointing device characterized by including a position information detecting means for detecting position information on positions indicated by the pointing device, wherein, based on the position information, the position information detecting means samples the move distance between said indicated positions per unit time and determines the amount of change of said object to change on said display screen, based on the duration of sampling during which the sampled move distance between said indicated positions per unit time exceeds a threshold continuously.

10. A display device associated with a pointing device for use to operate upon an object to change on a display screen, the display device characterized by including a change amount determining means, wherein, based on position information on positions indicated by said pointing device, the change amount determining means samples the move distance between said indicated positions per unit time and determines the amount of change of said object to change on said display screen, based on the duration of sampling during which the sampled move distance between said indicated positions per unit time exceeds a threshold continuously.

11. A display system comprising a display device and a pointing device associated with the display device and for use to operate upon an object to change displayed on a display screen by said display device, the display system characterized by including:
an angular velocity detecting means for detecting angular velocity information on positions indicated by said pointing device;
a move information sampling means for sampling the move distance between said indicated positions per unit time, based on the angular velocity information detected by the angular velocity detecting means; and
a change amount determining means for determining the amount of change of said object to change on said display screen, based on the duration of sampling during which the move distance between said indicated positions per unit time, sampled by the move information sampling means, exceeds a threshold continuously.

12. A display system comprising a display device and a pointing device associated with the display device and for use to move a pointer position pointing on a display screen displayed by said display device, the display system characterized by including:
a position information detecting means for detecting position information on positions indicated by said pointing device;
a move information sampling means for sampling the move distance between said indicated positions per unit time, based on the position information detected by the position information detecting means; and
a move distance determining means for determining a distance by which said pointer position should be moved, based on the duration of sampling during which the move distance between said indicated positions per unit of time, sampled by the move information sampling means, exceeds a threshold continuously.
